(19) United States
(12) Patent Application Publication
(10) Pub. No.: US 2025/0217687 A1
(43) Pub. Date: Jul. 3, 2025

(54) OPTICALLY ADDRESSABLE MOLECULAR-SPIN QUBIT DILUTED IN A HOST MATRIX

(71) Applicants: THE UNIVERSITY OF CHICAGO, CHICAGO, IL (US); MASSACHUSETTS INSTITUTE OF TECHNOLOGY, CAMBRIDGE, MA (US)

(72) Inventors: DAVID AWSCHALOM, CHICAGO, IL (US); PRATITI DEB, CHICAGO, IL (US); SAM BAYLISS, SAFFRON WALDEN (GB); DANIEL LAORENZA, CAMBRIDGE, MA (US); MYKYTA ONIZHUK, CHICAGO, IL (US); GIULIA GALLI, CHICAGO, IL (US); DANNA FREEDMAN, EVANSTON, IL (US)

(21) Appl. No.: 18/845,790

(22) PCT Filed: Mar. 10, 2023
(86) PCT No.: PCT/US2023/015009

§ 371 Date: Sep. 10, 2024

Related U.S. Application Data
(60) Provisional application No. 63/269,186, filed on Mar. 11, 2022.

(51) Int. Cl. G06N 10/40

(52) U.S. Cl. CPC G06N 10/40

(57) ABSTRACT

A molecular-spin qubit includes a molecular color center having a ground state and an excited state. The ground state has non-zero spin with at least first and second sublevels. The molecular-spin qubit also includes a host matrix that is non-isostructural with the molecular color center. The molecular color center is diluted in the host matrix. An optical transition between the ground and excited states lies in the optical region of the electromagnetic spectrum. A spin transition between the first and second sublevels lies in the microwave or millimeter-wave regions of the electromagnetic spectrum. Each of the first and second sublevels is first-order insensitive to magnetic fields near zero magnetic. The molecular color center and host matrix may each be formed from strong-field ligands bound to a metal-atom center. One example of the molecular-spin qubit is Cr(IV)(o-toyl)₄ diluted in a host matrix of Sn(IV)(4-fluoro-2-methylphenyl)₄.

### RELATED APPLICATIONS

This application claims priority to U.S. Provisional Patent Application No. 63/269,186, filed on Mar. 11, 2022, the entirety of which is incorporated herein by reference.

### STATEMENT REGARDING FEDERALLY SPONSORED RESEARCH OR DEVELOPMENT

This invention was made with government support under grant number N00014-17-1-3026, awarded by the Office of Naval Research, and grant number DE FOA-0002253, awarded by the Department of Energy. The government has certain rights in the invention.

### BACKGROUND

Quantum information science promises to revolutionize computational, sensing, and networking capabilities [1-4]. Innovations in these areas often rely on optimization of the quantum bit, or qubit, the fundamental unit of quantum information processing.

### SUMMARY

Optically addressable spin systems are a powerful platform for quantum information science due to their combination of a long-lived qubit with a spin-photon interface for external qubit control and read out. The ability to chemically synthesize such systems (i.e., to generate optically addressable molecular-spin qubits) offers a modular qubit architecture which can be transported across different environments, and atomistically tailored for targeted applications through bottom-up design and synthesis.

The present embodiments include species of optically addressable molecular-spin qubits whose spin coherence can be controlled by engineering the qubit's host environment. By inserting these molecular qubits into a lower symmetry, non-isostructural host matrix, transverse zero-field splittings result in noise-insensitive transitions that are not present for the same molecular qubit diluted in its isostructural host. This host-matrix engineering generates spin-coherence times of more than 10 μs for an optically addressable molecular-spin qubit in a nuclear and electron-spin rich environment.

Through first-principles coherence calculations, we model the dependence of spin coherence on transverse zero-field splitting. We experimentally verify these calculations with a series of distinct molecular-qubit species. Finally, we explore how to enhance optical-spin interfaces in molecular qubits by investigating optical linewidth and spin-lattice relaxation times. These results highlight how molecular qubits could be used for nanoscale quantum sensing in noisy environments, the ability to test qubit structure-function relationships through a tunable molecular platform, and opportunities for qubit architectures to be created from the bottom-up.

### BRIEF DESCRIPTION OF THE FIGURES

FIG. 1A illustrates molecular structure of Cr(IV)(o-tolyl)₄, also referred to herein as 1-Cr. Hydrogen atoms are omitted for clarity. FIG. 1A also illustrates single-crystal packing diagram of 1-Cr in its isostructural host Sn(IV)(o-tolyl)₄ (also referred to herein as 1-Sn, see left panel) and nonisostructural host Sn(IV)(4-fluoro-2-methylphenyl)₄ (also referred to herein as 2-Sn, see right panel), showing only positions of metal centers. The cell volumes for the representations of 1-Sn and 2-Sn are 9 and 10 nm³, respectively. Below each cell is the molecular structures of the corresponding tin host (1-Sn in the left panel, 2-Sn in the right panel), with hydrogen atoms omitted for clarity. The resulting ground-state spin structures (see the bottom of the left and right panels) show the formation of a clock transition (E>0) induced in a crystal of 1-Cr diluted in the host matrix 2-Sn (also referred to as 2).

FIG. 1B is an energy level diagram of chromium molecular color centers, highlighting resonant excitation to, and photoluminescence (PL) from, the S=0 excited state and zero-field splitting of the ground-state spin sublevels.

FIG. 1C is a plot of PL and photoluminescence excitation spectra of 2 at 4 K.

FIG. 2A is a plot of continuous-wave optically detected magnetic resonance (cw-ODMR) spectrum for a single crystal of 2 as a function of the magnetic field and microwave frequency overlaid with simulated spin transition frequencies (dashed lines). The ODMR spectrum yields D=5.55 GHz and E=1.85 GHz.

FIG. 2B is a plot of calculated spin-sublevel energies as a function of the magnetic field, highlighting their magnetic-field insensitivity.

FIG. 2C is a plot of a pulsed ODMR spectrum at zero magnetic field, demonstrating an optical contrast of approximately 40%. The inset shows a pulsed ODMR sequence with optical initialization, microwave, and optical readout pulses.

FIG. 3A illustrates the molecular structures of the host matrix for 1 (i.e., 1-Cr diluted in 1-Sn), 2, and 3 (i.e., Cr(IV)(2,3-dimethylphenyl)₄ diluted in Sn(2,3-dimethylphenyl)₄) with their simulated spin energy levels as a function of the magnetic field.

FIG. 3B is a plot of Hahn-echo traces for single crystals of 1, 2, and 3 at zero magnetic field.

FIG. 3C is a plot of zero-field spin coherence as a function of the transverse zero-field splitting. Also shown is the theoretical dependence calculated from first-principles gCCE methods.

FIG. 3D shows plots of experimental and calculated spin-coherence time T₂ as a function of the magnetic field.

FIG. 4 illustrates measurement of the homogeneous optical linewidth for 2.

FIG. 5A is a plot illustrating optical-spin initialization, which is observed as a reduction in photoluminescence over the course of an applied laser pulse.

FIG. 5 is a plot of spin-lattice relaxation time, as measured by an all-optical sequence of initialization and readout laser pulses separated by a variable relaxation time T.

FIG. 6A shows a 400-MHz ¹H nuclear magnetic resonance (NMR) spectrum of 2 in CDCl₃ at room temperature. ChemDraw molecular structure indicates the peak assignment given by the shading of the highlighted H atom and the corresponding peak. The inset highlights the peak splitting of the aromatic ¹H nuclei.

FIG. 6B shows a 101-MHz ¹³C NMR spectrum of 2 in CDCl₃ at room temperature. ChemDraw molecular structure indicates the peak assignment given by the shading of the highlighted C atom and the corresponding peak. The individual peaks show a splitting that corresponds to J coupling of the ¹³C nuclei with the ¹⁹F nucleus. The largest J-coupling value of 248.0 Hz corresponds to the carbon atom directly bound to the fluorine atom.

FIG. 6C shows a 376-MHz ¹⁹F NMR spectrum of 2 in CDCl₃ at room temperature. The inset shows the splitting of the central peak, likely a result of coupling to surrounding ¹H nuclei.

FIG. 6D shows a 149-MHz ¹¹⁹Sn NMR spectrum of 2 in CDCl₃ at room temperature, with the inset showing the unresolved splitting of the single peak.

### DETAILED DESCRIPTION

### Introduction

Solid-state color centers offer a well-developed qubit platform with a robust spin-photon interface for single qubit initialization and readout [5-7] and microwave-frequency spin transitions for coherent control. Introducing these properties into tunable and portable molecular systems combines the key properties of solid-state color centers with opportunities for optimization through bottom-up engineering of both the qubit and its environment [8, 9]. These optically addressable molecular systems, also known as “molecular color centers,” provide Angstrom-scale precision and tunability of the local qubit environment [10-13], enabling targeted design for applications such as nanoscale quantum sensing in noisy environments. Additionally, the ground-state spin hosted in a molecule comprises a portable qubit of <1 nm³ size, such that these systems can be readily integrated into various host matrices and hybrid materials architectures [17-19].

Altering the crystallographic symmetry of solid-state color centers is known to enhance qubit properties. The portability of molecular qubits opens up a versatile platform to achieve such enhancements by modifying a qubit's electronic structure through host-matrix tuning, without altering the chemical composition of the qubit. In particular, the sensitivity of the ground-state spin to its local environment suggests that we may use the crystallographic symmetry of the host matrix to induce “clock transitions” which are first-order insensitive to magnetic-field noise, and hence can enhance spin coherence, even in noisy (e.g., nuclear spin-rich) environments. As demonstrated in molecular qubits that lack a spin-photon interface [21, 22] and solid-state color centers [23, 24], such transitions reduce the need for isotopic control of the nuclear spin environment (e.g., deuteration [25]) or high qubit dilution to achieve long coherence times.

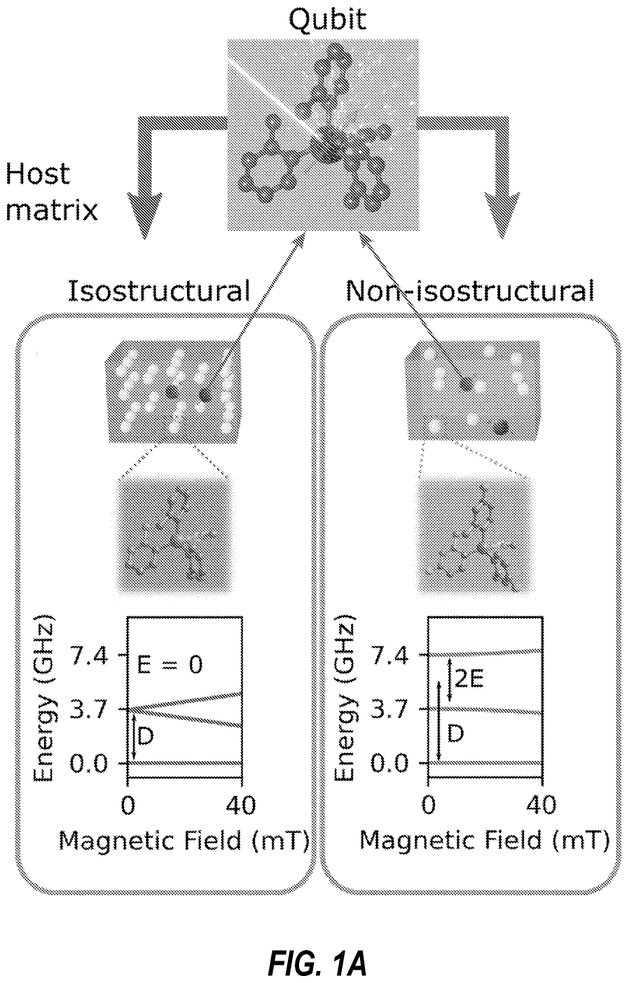

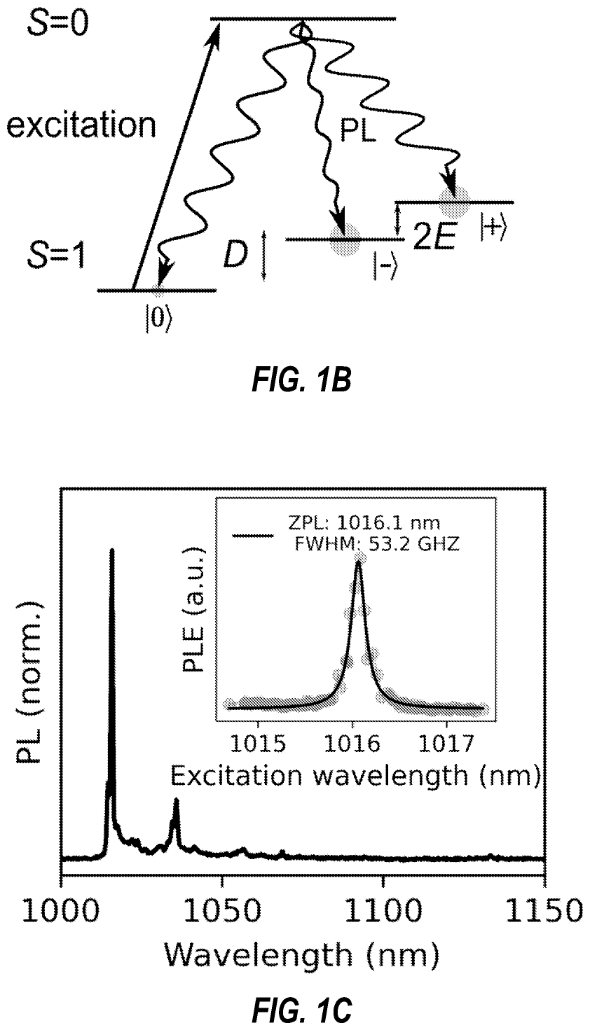

The present embodiments include species of optically addressable molecular-spin qubits that, through host-matrix-induced symmetry control, form clock transitions (i.e., a transition between two magnetic sublevels, each of which is first-order insensitive to magnetic fields near zero magnetic field). Some embodiments use the chromium-based molecular color center Cr(IV)(o-tolyl)₄. For clarity, this molecular color center is also referred to herein as 1-Cr (see FIG. 1A). The crystallographic symmetry of 1-Cr and its isostructural, diamagnetic host Sn(IV)(o-tolyl)₄ (denoted herein as 1-Sn) yields ground-state spin transitions that are first-order sensitive to magnetic-field fluctuations (see left panel in FIG. 1A). By contrast, inserting 1-Cr into a non-isostructural, lower symmetry host matrix, such as Sn(IV)(4-fluoro-2-methylphenyl)₄ (denoted herein as 2-Sn), induces clock transitions as a result of significant transverse zero-field splitting (see right panel in FIG. 1A). This host-induced symmetry breaking enhances the spin coherence of 1-Cr in 2-Sn (denoted herein as 2) compared to 1-Cr in the isostructural 1-Sn host (denoted herein as 1). We model this behavior from first principles using generalized cluster-correlation expansion methods, and further experimentally demonstrate enhanced optical contrast and spin-lattice relaxation times for these host-matrix engineered molecular color centers. Remarkably, the host modification to achieve this coherence enhancement comprises interchange of just one hydrogen atom on the host ligands with a fluorine atom. Thus, the coherence enhancement arises from symmetry control by the host and does not rely on isotopic control of the nuclear spin environment, offering a pathway for coherence-protected quantum sensing (e.g., of electric fields and strain) in intrinsically noisy environments (e.g., biological systems).

While systems 1 and 2 are used herein to illustrate the impact of the host environment on the ground-state spin structure, the present embodiments include other species of molecular color centers and host matrices. The present embodiments may also be extended to solid-state color centers (e.g., the basal divacancy defect in SiC).

### Host-Matrix-Induced Clock Transitions in a Molecular Color Center

We recently demonstrated optical addressability of molecular spin qubits comprising a chromium (Cr⁴⁺) ion coordinated by organic ligands in a pseudo-tetrahedral geometry such as 1-Cr (see FIG. 1A) [10]. The symmetry and tetravalent oxidation state of 1-Cr leads to a spin-triplet (S=1) ground state while the strong-field organic ligands generate a suitable energy level structure for optical spin initialization and readout (see energy-level structure in FIG. 1). As a result, the ground state can be optically initialized and read out using spin-selective excitation to the spin-singlet (S=0) excited state, combined with photoluminescence (PL) detection, analogous to solid-state color centers. Specifically, resonantly exciting these molecular-spin qubits with a narrow-linewidth laser initializes the ground state through optical pumping: selective excitation of a spin sublevel (e.g., |0 [symbol] in FIG. 1), combined with excited-state decay, transfers population to the other spin sublevels (e.g., ±) in FIG. 1i). Similarly, the same selective excitation enables optical spin readout through the resulting PL: spin sublevels resonant with the laser will be excited and give rise to PL, while the detuned spin sublevels will be only weakly excited and therefore give rise to weak (ideally vanishing) PL. Combined with microwave control of the ground state spin, these properties therefore provide a qubit which can initialized, coherently controlled, and read out in a fashion which is compatible with single-spin detection.

For 1, the axial zero-field splitting of D=3.63 GHz splits the m=0 sublevel |0 [symbol] from the m=±1 sublevels |±1 [symbol] . In the tetragonally symmetric crystal environment of 1, the Cr⁴⁺ site contains a four-fold improper rotational axis (S₄) that enforces the transverse zero-field splitting E to be approximately 0, resulting in spin transitions that are first-order sensitive to magnetic fields (see left panel in FIG. 1A). However, for |E|>0, the degeneracy of the zero-field states is broken: the |±1 [symbol] states hybridize to form the non-degenerate levels |= [symbol] =(|+1)±|−1))/\sqrt{2}, which have no first-order magnetic moment. Therefore, systems with |E|>0 exhibit transitions which are first-order insensitive to magnetic fields around B=0 (see right panel in FIG. 1A), where B is an external magnetic field. To achieve |E|>0 with 1-Cr, we introduce 1-Cr into the non-isostructural host matrix 2-Sn (see right panel in FIG. 1A), which contains no three-fold (or higher) rotational axes such that E is no longer symmetry-constrained to zero.

As a demonstration of the present embodiments, 1-Cr was synthesized and diluted in 1-Sn and 2-Sn to form dilute single crystals of 1 and 2, respectively [28, 29]. Individual crystals of 1 and 2 were mounted on a microwave coplanar waveguide inside an optical cryostat at ˜4 K (see “Experimental Methods” below). We determined the optical structure of 2 through PL measurements: upon off-resonant excitation at 785 nm, we measured PL from the spin-singlet excited state to the spin-triplet ground state. Similar to 1, the spectrum of 2 shows a relatively high Debye-Waller factor, and a resolved phonon side band, with a zero-phonon line (ZPL) at 1016 nm (compared to 1025 nm for 1).

FIG. 1C shows the photoluminescence excitation (PLE) spectrum taken by sweeping a narrow-linewidth laser across this ZPL and detecting photons from the phonon side band, from which we find an inhomogeneous broadening of ≅50 GHz (full-width half-maximum). For all following experiments, we investigated the behavior of a narrower subensemble of the overall spin centers by exciting with a narrow-line laser at the ZPL maximum and detecting photons in the phonon side band.

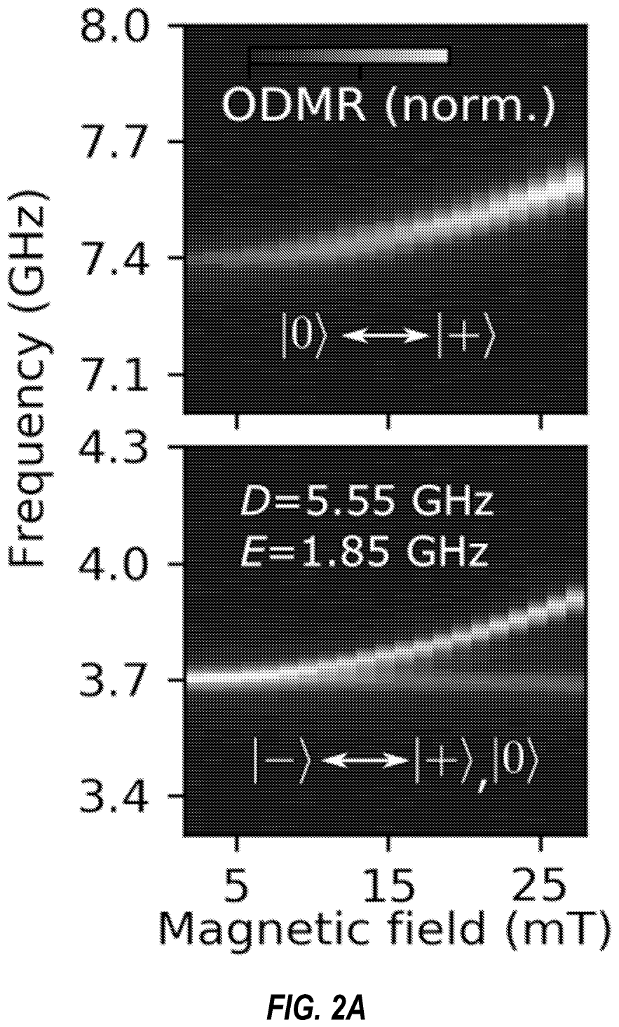

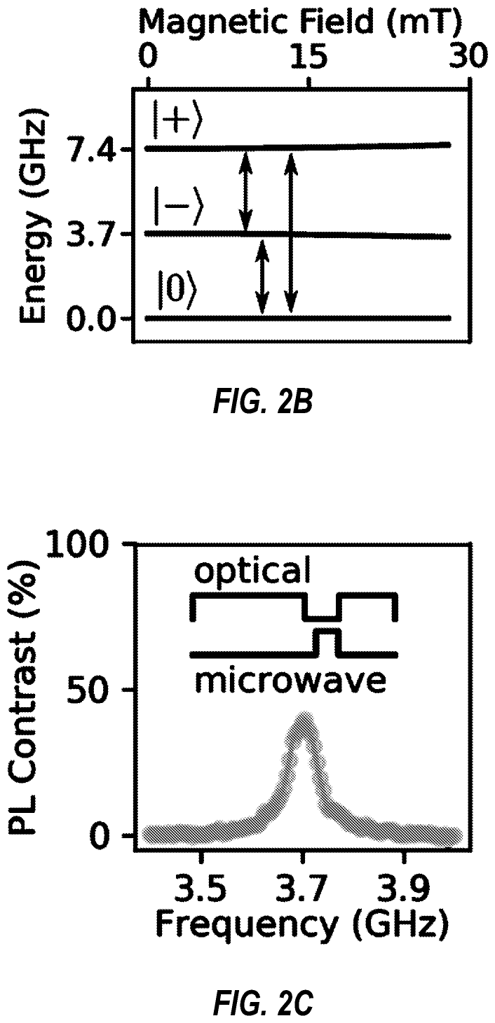

We then determined the ground state zero-field splitting parameters of 2 through continuous-wave optically detected magnetic resonance (cw-ODMR). Under continuous optical excitation, applying a microwave frequency on resonance with a transition between spin sublevels of 2 increases the PL due to the mixing of the “bright” and “dark” spin sublevels, i.e., the sublevels which are resonant with and detuned from the laser, respectively. FIG. 2A shows the cw-ODMR spectrum as a function of both magnetic field and microwave frequency, from which we extracted D=5.55 GHz and E=1.85 GHz. Importantly, compared to 1, in which E=0, the use of a lower symmetry host matrix in 2 generates a significant transverse zero-field splitting. In fact, 2 displays the largest possible transverse zero-field splitting (E) for its axial zero-field parameter (D) (i.e., |E|=|D|/3), highlighting the significant symmetry breaking afforded by the host-matrix. In this system, where |E|=|D|/3, two of the spin transitions are degenerate and hence we observe two resonances (at D−E=2E and D+E) at zero-field, with the degeneracy lifted under an applied magnetic field. We further note that since the sign of D and E are not determined in our experiments, and do not influence our results, we take D, E>0 for concreteness. The field-frequency ODMR map highlights the insensitivity of the spin transitions to magnetic field: to first order the energy of the |0 [symbol] , |− [symbol] , and |+ [symbol] sublevels do not shift with increasing field, in contrast to the linear Zeeman shift found for E=0 in 1.

### Host-Matrix-Enhanced Spin Coherence

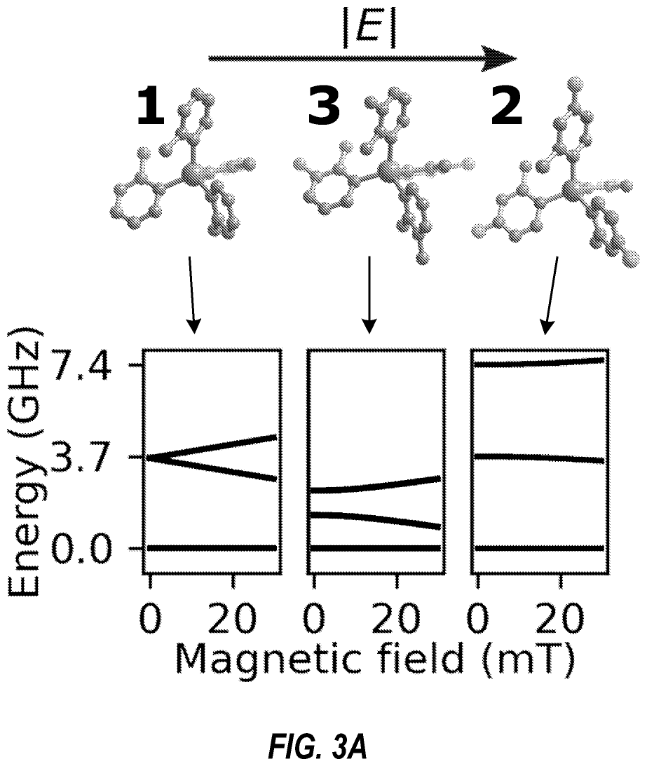

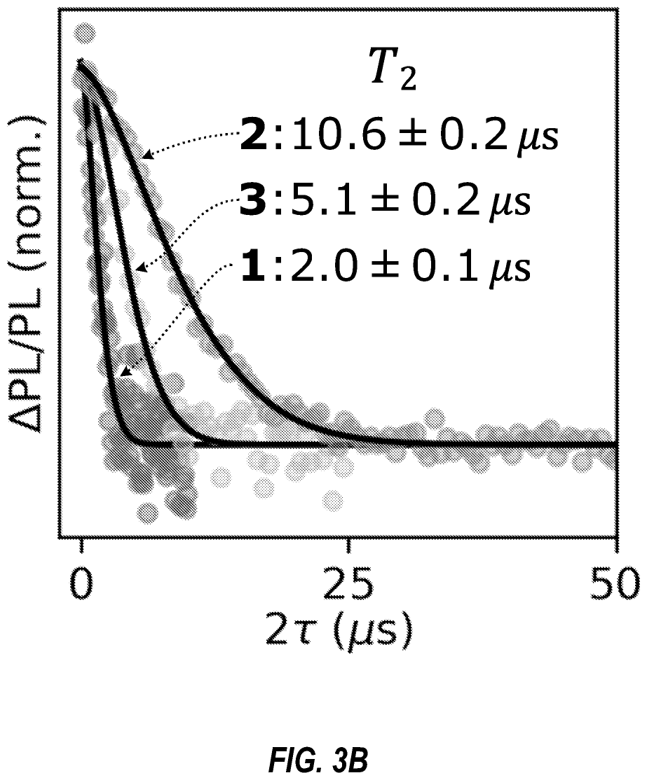

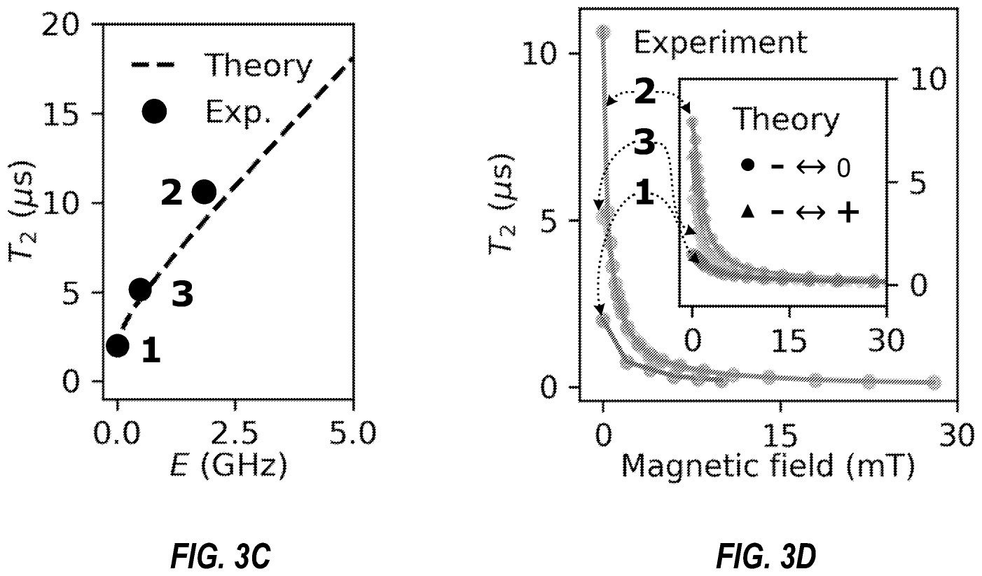

We now illustrate how this behavior significantly enhances the spin coherence (T₂) in 2 compared to 1. As a prerequisite for optically detected spin-coherence measurements, we performed pulsed ODMR by applying the pulse sequence in FIG. 2C. A laser pulse initialized the subensemble of spins, which were then rotated by a microwave w-pulse before being read out through the PL with a second laser pulse. FIG. 2C also shows the pulsed ODMR spectrum as a function of microwave frequency at B=0 for the (doubly degenerate) low-frequency transitions (at D−E=2E=3.7 GHz). We find an ODMR contrast of 40% (defined such that the maximum possible contrast is 100%, see “Experimental Methods” below), which is approximately an order of magnitude improvement from our previous demonstration with 1. To measure the spin coherence of 2, we replaced the microwave w-pulse with a Hahn-echo sequence (i.e., a π/2−τ−π−τ sequence, where 2τ is the free-evolution time) followed by an additional π/2 pulse to project coherences onto populations for optical readout (see FIG. 3B). At zero magnetic field, we measured a ground-state spin-coherence time T₂=10.6±0.2 μs despite the nuclear spin rich environment and the relatively high Cr concentration (≅1%). Measuring T₂ for 1 at zero-magnetic field, we find a significantly shorter T₂=2.0±1 s, indicating the effectiveness of the clock transition in 2 for enhancing spin coherence.

To further understand the dependence of zero-field spin coherence on the transverse zero-field splitting, we investigated two other compounds: Cr(IV)(2,3-dimethylphenyl)₄ diluted in Sn(2,3-dimethylphenyl)₄ (denoted herein as 3), and Cr(IV)(2,4-dimethylphenyl)₄ diluted in Sn(2,4,-dimethylphenyl)₄ (denoted herein as 4) [10]. The additional methyl group on the ligands of these compounds induces lower symmetry crystal packing than 1, and consequently E is ≅0.5 GHz in both cases, providing additional testbeds of the role of the transverse zero-field splitting in enhancing spin coherence, here from tuning the qubit rather than the host matrix. FIG. 3C plots the zero-field coherence time for 1, 2, and 3, showing that T₂ increases with increasing E. System 4 has a similar T₂ to 3 due to it similar value of E. Generally, these systems highlight paths to engineer even longer coherence times through independently optimizing both the host matrix and the chemical composition of the qubit.

To further understand the spin coherence of these molecular color centers interacting with the nuclear spin bath, we used first principles generalized cluster correlation expansion (gCCE) calculations with Monte Carlo bath state sampling using the PyCCE package. Starting from the crystal structure for these compounds, we calculated the electron-nuclear hyperfine couplings of the Cr-containing molecule using Density Functional Theory (DFT). Using DFT-computed spin densities, we calculated the interactions between the Cr center and nuclear spins in the host matrix and took point dipole-dipole interactions between nuclear spins. The calculated zero-field T₂ vs. transverse zero-field splitting E shows good agreement with the experimental values (see simulation line in FIG. 3C). Since the calculations only consider the nuclear spin bath, they highlight that Cr electronic spins are not a major limitation on the coherence. Interestingly, the calculations also allow us to determine the distance at which nuclear spins play a significant role in determining the coherence. By varying the number of nearest neighbor molecules included in the calculations, we found convergence for 3-4 nearest neighbors, corresponding to a radius of ˜1.5 nm around the Cr center.

The behavior of molecular spin coherence in the low magnetic field regime (from 0 to ˜100 mT) has largely been unexplored but, as demonstrated in solid-state color centers, is an important domain for applications in quantum information science. To further explore the impact of magnetic field in this regime on molecular color centers, we measured T₂ as a function of magnetic field for 1, 2, and 3. In each case, T₂ decreases with increasing magnetic field between 0 and 30 mT (see FIG. 3D), likely resulting from interactions with the nuclear spin bath, as demonstrated by the good agreement with the experimental data and the gCCE calculations. A similar behavior, albeit with a much lower characteristic field scale, has been studied in defects in semiconductors, where the coherence initially drops with magnetic field to a minimum due to nuclear spin bath effects, before recovering when the nuclear Zeeman splitting dominates over the electron-nuclear and nuclear-nuclear interactions. In these molecular qubits, the characteristic field scale is much larger due to the stronger electron-nuclear and nuclear-nuclear interactions. Hence, we only see the reduction in T₂ in the measured field range. We note, however, that ESR measurements performed at higher magnetic fields (≅200-500 mT) show that the T₂ does once again increase at high magnetic fields. Our calculations therefore present a robust methodology for a range of molecular qubit platforms and provide important insights and tools for optimal engineering of these systems. Overall, the ability to synthesize, measure, and model the spin dynamics in a series of tunable molecular qubits highlights the opportunities provided by this molecular platform for testing, measuring, and optimizing structure-function relationships of optically addressable spin qubits.

### Key Parameters to Optimize Molecular Spin-Optical Interfaces

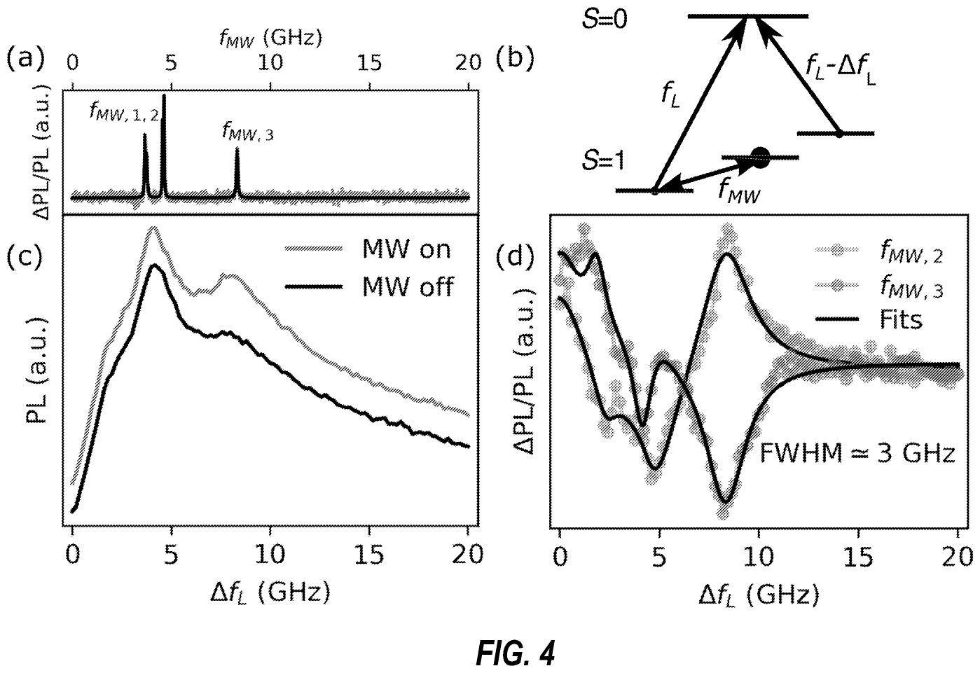

Having shown how host-matrix engineering can enhance the coherence of molecular color centers, we now explore additional key properties of 2. The optical linewidth is a crucial parameter in these molecular systems: It determines the readout and initialization fidelity by setting the spin selectivity of the excitation. Quantifying this linewidth is, therefore, an important step to further optimize molecular color centers. To measure the homogeneous optical line-width (i.e., that of the subensemble of spins probed under resonant excitation), we perform a two-laser-tone experiment. We apply a fixed laser tone, at frequency f_{L}, along with a second laser tone, detuned by Δf_{L}, which we sweep. When the difference Δf_{L} in laser frequencies matches the spin transition frequencies, the second laser tone excites population that is shelved in other (dark) spin sublevels, thus increasing the PL (see panel (b) in FIG. 4). Similarly, when Δf_{L}=0, the PL is lower than for a finite detuning since the population is already shelved in the dark sublevels by the first laser tone. The linewidths of these spectral peaks and holes enable us to determine the homogeneous optical linewidth of the subensemble—which determines the spin-optical contrast—from the inhomogeneously broadened ensemble (see FIG. 4).

To mitigate the slope in the PL traces (see panel (c) in FIG. 4)) caused by the inhomogeneous broadening, we used a differential ODMR measurement. Specifically, we applied a fixed microwave drive f_{MW} at the frequency of one of the spin transitions and measured the ODMR signal as we swept Δf_{L}. From a fit to these measurements, we extracted an optical linewidth of ≅3 GHz for 2 (see panel (d) in FIG. 4). Importantly, since this is comparable to the zero-field splitting parameters, this indicates promise for significantly improving molecular spin-optical interfaces by lowering linewidths. We note that similar spin-flip, intraconfigurational optical transitions in coordination compounds exhibit homogeneous linewidths on the order of 10-100 MHz, suggesting avenues for future improvements through, e.g., lower temperatures, selective deuteration, or reduced Cr⁴⁺ concentration.

FIG. 4 illustrates measurement of the homogeneous optical linewidth for 2. Panel (a) of FIG. 4 shows ODMR with the relevant microwave transitions. Panel (b) of FIG. 4 is a schematic of the two-color experiments showing a fixed laser tone f_{L} and a sideband detuned by Δf_{L}, which is swept. Panel (c) of FIG. 4 is a plot of PL as a function of Δf_{L} with and without a microwave drive. Panel (d) is a plot of ODMR as a function of Δf_{L} for applied microwave tones at f_{MW,2} and f_{MW,3} (≅8.3 GHz) with fits yielding a homogeneous optical linewidth of ≅3 GHz.

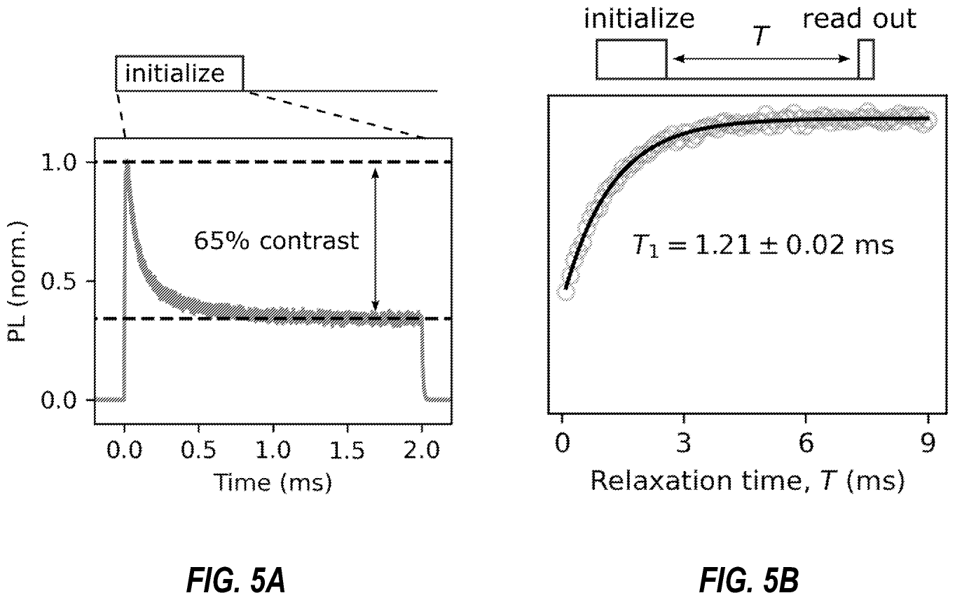

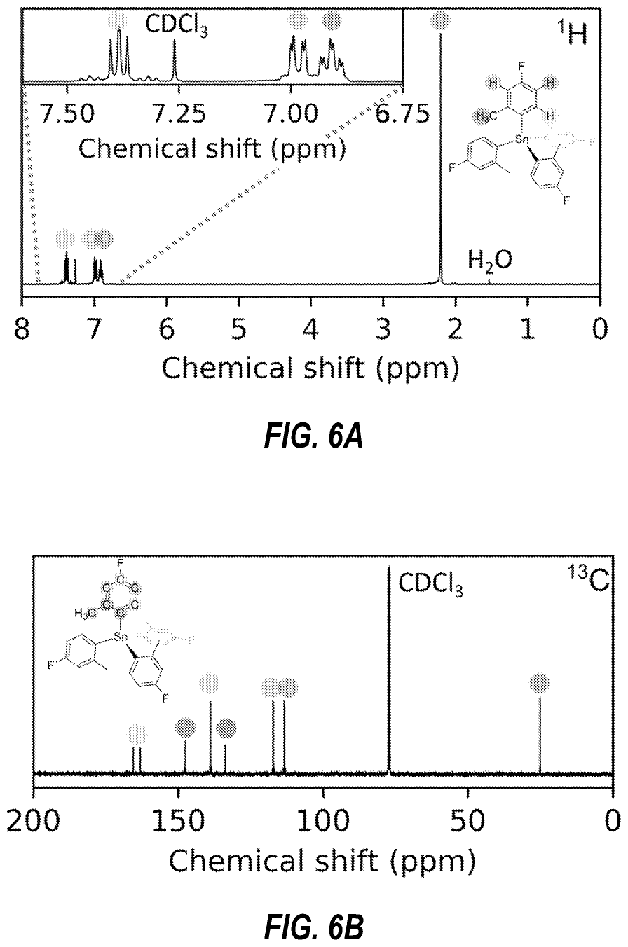

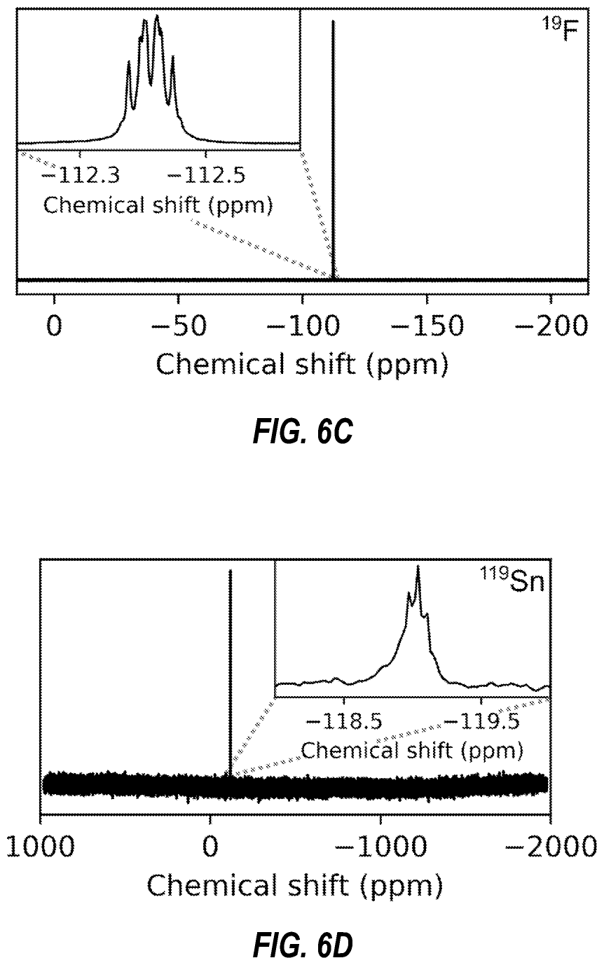

We next measured the resulting optical contrast of 2—which provides a lower bound on the spin polarization—by applying an optical pulse (2 ms long) and measuring the emitted photons during this pulse, followed by a wait time much greater than the spin-lattice relaxation time for ground-state equilibration before the next repetition of the experiment. Over the course of the optical pulse, the PL decreases as spins are optically pumped from the probed bright spin sublevel to the dark spin sublevels. The difference in PL at the beginning and the end of the pulse provides a lower bound on the spin polarization of 65% (see FIG. 5A). This is a marked improvement on 1, where we previously observed a contrast of 14% [10]. We then measured the spin-lattice relaxation time T₁ of the ground-state spin by applying an optical initialization pulse, followed by a variable relaxation time T, before measuring the relaxation of the spins through a readout pulse during which we collect the PL. By varying the relaxation time, we measure T₁=1.21±0.02 ms (see FIG. 5B), a fivefold improvement compared to our previous measurements of 1.

The improved optical contrast and longer T₁ of 2 suggests that either the thermalization of the sample and/or the crystal quality of the sample is improved relative to 1. For example, 1 exhibits T₁ times of ˜5 ms and <1 ms at 5 and 8 K, respectively, highlighting the dramatic influence of temperature on T₁. Thus, a five-fold enhancement of T₁ for 2 relative to 1 could result from a decrease in effective temperature at the sample of 2-3 K. Additionally, the increased IDI of 2 should result in improved spin selectivity of resonant optical excitation, also providing a mechanism to improve the optical contrast observed here. Thus, improving sample thermalization and modifying IDI to larger, yet still measurable, values offer straightforward routes to optical contrasts approaching 100% for molecular color centers. Overall, these measurements show how key molecular qubit properties can be engineered through host-matrix control.

### Synthesis

Glassware was either oven-dried at 150° C. for at least four hours or flame-dried prior to use. Toluene, tetrahydrofuran (THF), diethylether (Et₂O), and hexanes were dried using a commercial solvent purification system from Pure Process Technology and stored over 4 Å sieves prior to use. All solvents were subjected to a test with a standard purple solution of sodium benzophenone ketyl in THE to confirm low O₂ and H₂O content prior to use. 2-Bromo-5-fluorotoluene and magnesium (Mg) ribbon were purchased from Sigma Aldrich and used as received. Tin tetrachloride was purchased from Alfa Aesar and used as received. 1-Cr (Cr(o-tolyl)₄), 2-Cr (Cr(2,3-dimethylphenyl)₄), 3-Cr (Cr(2,4-dimethylphenyl)₄), 1-Sn (Sn(o-tolyl)₄), and Sn(2,3-dimethylphenyl)₄, and Sn(2,4-dimethylphenyl)₄, were synthesized under a N₂ atmosphere with either an MBraun Unilab Pro glovebox, Vacuum Atmosphere Nexus II glovebox, or Schlenk techniques according to previously published literature methods [10, 28, 29]. 4-fluoro-2-methylphenylmagnesium bromide was prepared with slight modifications to literature procedure (see below). Once synthesized, all tin compounds are air stable and as such, may be worked up and handled outside of an inert atmosphere. Similarly, cocrystallized Cr:Sn single crystals and microcrystalline samples are stable over the course of several days after ambient exposure before noticeable loss of visible absorption intensity.

Synthesis of tetrakis(4-fluoro-2-methylphenyl)stannane (2-Sn): Mg ribbon (2.6 g, 106 mmol, 4 equiv.) was cut into ˜3-4 mm long pieces into a dry 250-mL three-neck round bottom flask under positive pressure of N₂. [Synthetic note: the freshly cut Mg ribbon typically resulted in faster initiation in the formation of the Grignard reagents than magnesium turnings.] The Mg ribbon was then “knocked” (i.e., stirred) with a magnetic stir bar at the maximum rate of the stir plate for 16 hours under vacuum to further activate the Mg ribbon. The flask was then returned to a positive pressure of N₂ and 100 mL of Et₂O was added via cannula. The three neck round bottom flask was fitted with a reflux condenser and an addition funnel. Approximately 5-10% of a solution of 2-Bromo-5-fluorotoluene (5 g, 26.5 mmol, 1 equiv.) in 25 mL of Et₂O was added dropwise through the addition funnel to the stirring mixture of Mg and Et₂O. Upon initiation of the reaction when the solvent began to visibly boil, the remainder of the solution in the addition funnel was added dropwise over ˜10 minutes with continuous stirring to the reaction flask. The reaction was then heated under reflux conditions for 2 hours. The reaction flask was then cooled down to room temperature and filtered through a fritted Schlenk funnel to remove excess Mg. The resulting solution was then cooled to 0° C., at which point SnCl₄ (1.12 g, 4.33 mmol, 1/6 equiv.) was added dropwise to the solution via a syringe. A white solid precipitated immediately upon addition, likely an insoluble SnCl₄-Et₂O adduct. The reaction flask was then brought back to reflux conditions for 18 hours, over which time the white solid was solubilized in the reaction mixture. The reaction mixture was cooled to room temperature and 2-3 mL of a 1% hydrochloric acid (HCl) aqueous solution was added dropwise to the reaction mixture to quench excess 4-fluoro-2-methylphenylmagnesium bromide. Note that this step can result in substantial heating if a large amount of 4-fluoro-2-methylphenylmagnesium bromide remains. Do not add the HCl solution rapidly to the reaction flask. Once no heating occurred upon dropwise addition of the HCl solution to the reaction mixture, 100 mL of the 1% HCl solution was added to the reaction flask slowly. The mixture was transferred to a separatory funnel. The aqueous layer was washed with 3×75 mL of Et₂O. The combined organic washes were then dried with magnesium sulfate and the solvent was removed with rotary evaporation. The crude product was isolated as either a yellowish oil or a yellow solid. The resulting oil was extracted into toluene (˜10 mL) and filtered through a pad of celite to remove any insoluble solids. The toluene solution was then layered under 10 mL of hexanes in a 20 mL scintillation vial. The vial was stored at −35° C. for one week, at which point colorless crystals suitable for X-ray diffraction were collected. Typical reaction yields based on resulting crystalline product were 0.75-1.0 g (1.35-1.8 mmol, 31-42% yield based on the Sn pre-cursor). Crystalline product could also be obtained via THF/hexanes or DCM/hexanes layering at −35° C. or slow diffusion of hexanes into toluene, THF, or DCM.

### Crystallization and X-ray Structure Determination

All crystallizations were carried out under a N₂ atmosphere in a Vacuum Atmosphere Nexus II glovebox. Diluted crystals of 1, 3, and 4 were prepared as described previously [10]. In an analogous manner to these crystallization methods, 200 mg of 2-Sn and 2 mg of 1-Cr were dissolved in 3 mL of THF. This solution was filtered through Celite and then layered under 6 mL of Et₂O. The crystallization was left at −35° C. for four weeks, during which time transparent, pink crystals began to grow. The crystals were left to grow for another four weeks, at which point, several millimeter sized crystals had formed. One of these crystals were cleaved with a razor blade to obtain a sufficiently thin (˜100-200 micron thick) crystal. The thin crystal was essential to obtain sufficiently strong microwave field at the probed subensemble to drive the spin transitions in the pulsed ODMR experiments. Note, the diluted crystals are relatively stable in ambient atmosphere with no noticeable degradation over the course of ˜10 days. Manipulations with the crystals may, therefore, occur outside of a glovebox. To minimize the possibility of sample degradation, samples measured herein were handled and mounted on the coplanar waveguide (see “Experimental Methods” below) under a N₂ atmosphere inside of a glovebox.

Single-crystal X-ray diffraction data were collected in the X-ray crystallography lab of the Integrated Molecular Structure Education and Research Center (IMSERC) at Northwestern University. Single crystals of 2-Sn suitable for X-ray diffraction analysis were coated in Paratone N oil and mounted on a MiTeGen MicroLoop™. Single crystal data were collected on a Rigaku XtaLAB Synergy (Single source) with a micro-focus sealed X-ray tube PhotonJet (MoKa) radiation source, HyPix CCD detector and an Oxford Cryostream cooler. Raw data were integrated using CrysAlisPro. Absorption corrections were applied using multi-scan absorption correction with the SCALE3 ABSPACK module in CrysAlisPro [31]. The space groups of each compound were determined by examination of systematic absences, E-statistics, and successive refinement of the structure. Using the OLEX2 interface [32], the structures were solved with intrinsic phasing (SHELXT) methods [33] and further refined using least squares minimization with SHELXL [34]. Thermal parameters for all non-hydrogen atoms were refined anisotropically. All hydrogen atoms were fixed at ideal positions, refined using a riding model for all structures, and refined using isotropic displacement parameters derived from their parent atoms. Crystallographic details for 2-Sn are listed in the Table 1 below.

TABLE 1
Crystallographic data for the structure
refinement of 2-Sn measured at 100 K.

| | Sn(4-fluoro-2methylphenyl)₄(2-Sn) | |
|---|---|---|
| Empirical formula | C₂₈H₂₄F₄ Sn | |
| Formula weight | g/mol | |
| Temperature | 99.98(14) | |
| Radiation | MoKα (λ = 0.71073 Å) | |
| Crystal system | Orthorhombic | |
| Space group | Pbcn | |
| Unit cell dimensions | a = 16.5918(2) Å, α = 90° | |
| | b = 17.1973(2) Å, β = 90° | |
| | c = 17.0037(3) Å, γ = 90° | |
| Volume | 4851.74(12) | Å³ |
| Z | 8 | |
| Density (calculated) | 1.520 | g/cm³ |
| Absorption coefficient | 1.097 | mm⁻¹ |
| F₀₀₀ | 2224 | |
| Crystal color | Colorless | |
| Crystal size | 0.64 × 0.36 × 0.28 | mm³ |
| 2θ range | 2.3720 to 38.3420° | |
| Index ranges | −28 ≤ h ≤ 26 | |
| | −28 ≤ k ≤ 27 | |
| | −21 ≤ l ≤ 28 | |
| Reflections collected | 68023 | |
| Independent reflections | 12583 [Rᵢₙₜ = 0.0363] | |
| Absorption correction | Gaussian | |
| Data/restraints/ | 12583/0/302 | |
| parameters | | |

| Goodness-of-fit on F² | 1.024 |
|---|---|
| Final R indices [I > 2σ(I)] | R₁ = 2.77%, wR₂ = 6.38% |
| R indices (all data) | R₁ = 3.75%, wR₂ = 6.77% |
| Largest diff. peak and hole | 0.551 and −1.110 e · Å⁻³ |

### Experimental Methods

We used a cryogenic confocal microscopy setup to optically excite the molecular color centers and collect their photoluminescence. The molecular crystal sample was mounted on a coplanar waveguide for microwave delivery, which in turn was mounted inside a closed cycle cryostat (Montana Instruments, Cryostation s100) on an XYZ piezo stage (Attocube: 2ANPx101/RES/LT, 1ANPz102/RES/LT) to allow translation of the sample. To measure the photoluminescence spectrum in FIG. 1C, we used a 785-nm laser diode (Thorlabs, FPL785S-250). For all other experiments, we used resonant excitation at the zero-phonon line. We resonantly excited using a narrow-linewidth tunable laser (Toptica, DL pro) and shortpass-filter the excitation beam to remove spurious wavelengths. To monitor the resonant excitation wavelength and mode behavior, we used fiber beam splitters to direct parts of the beam into a wavemeter (Bristol, 621A) and a scanning Fabry-Perot interferometer, respectively (Thorlabs, SA200-8B). We used an acousto-optic modulator (AOM, Gooch and Housego 15200-0.93) driven by a radio frequency (RF) AOM driver (Gooch and Housego, R21200-1DS) to generate optical pulses. An arbitrary waveform generator (AWG, Tektronix, AWG5014C) set the timing for control pulses to all experimental components, including this RF driver. A linear polarizer (Thorlabs, LPNIR100-MP2), in conjunction with a motorized half-wave plate (HWP, Thorlabs, AIWP10M-980 and PRM1Z8), was used to control the optical polarization. The excitation beam passed through a broadband 50:50 beamsplitter (BS, Thorlabs, BSW29R), which separated the excitation and collection paths. A fast-steering mirror (Newport, FSM-300) was used to scan the laser across the sample. The excitation beam was focused onto the sample using a microscope objective (Olympus, LCPLN100XIR, NA=0.85) mounted inside the cryostat. The PL was collected by the same objective, reflected off the 50:50 BS, and the laser scatter was removed using a longpass filter. The PL was coupled either into a single-mode fiber to be detected with a superconducting nanowire single photon detector (SNSPD, Quantum Opus, Opus One) or into a multi-mode optical fiber. The multi-mode path was sent to a spectrometer (Acton, SpectraPro 2500i) combined with a CCD (Princeton Instruments, Pylon-IR), which was used for spectral measurements. Static magnetic fields were applied to the sample using a permanent magnet outside the cryostat. This magnet was mounted on a motorized linear translation stage (Zaber, X-LSQ150A) and the field at the sample was calibrated using a gaussmeter. For the homogeneous linewidth extraction, the laser sidebands were generated using an electro-optic modulator to which we supplied a microwave drive using a signal generator (Agilent, E8257D).

For the experiments involving gated readout (i.e., FIGS. 2A-C, 3A-B, 4, and 5B), the SNSPD output was amplified to a transistor-transistor logic level using a pulse converter (Pulse Research Lab, PRL-350TTL). These pulses were gated by switches (Minicircuits, ZASWA-2-50DRA+) that were controlled by the AWG and collected using counters in a data acquisition card (DAQ6363, National Instruments). For the hole-burning experiment (see FIG. 5A), the counts from the SNSPD were sent to a time tagger (Swabian Instruments, Time Tagger 20), which was triggered by the AWG. Microwave signals were generated by a signal generator (SG396, Stanford Research Systems or Agilent, E8257D). For pulsed ODMR experiments, microwave pulses were amplified using a high-gain, broadband amplifier (25S1G4A, Amplifier Research). For FIG. 2C, we defined the PL contrast as [PL(on)-PL(off)]/[PL(on)+PL(off)], where PL(on) and PL(off) are the PL on and off resonances, respectively. This definition ensures a maximum contrast of 100%. For the Hahn-echo experiments, we phase-cycled the final microwave pulse and took the difference in PL from the two phases.

### Conclusions and Outlook

This work demonstrates how symmetry engineering through atomistic host-matrix control of a molecular spin qubit can significantly enhance both spin coherence and spin-optical interfaces. Through host-based symmetry control, we have demonstrated spin coherence times exceeding 10 μs for an optically addressable molecular spin system in a nuclear- and electron spin-rich environment. These results therefore combine the advantages of noise-protected coherence with the requisite properties for qubit initialization, coherent control, and read at the single-spin level, all within a versatile molecular architecture. By exploring the role of the host-matrix on optical contrast, homogeneous optical linewidths, and spin-lattice relaxation times, our results highlight further directions to improve molecular spin-light interfaces (e.g., synthesizing qubits with greater structural rigidity, using lower temperatures to limit thermal vibrations, and engineering vibrational modes through isotope control and modification of the chemical makeup of the host matrix). As a result, the ability to transport molecular qubits between different environments, and tune these hosts with atomic level precision, highlights exciting opportunities for further control over a range of qubit properties (e.g., spin-orbit coupling) as well as heterogeneous integration with other devices (e.g., photonic or phononic devices). In particular, operating at zero magnetic field, the demonstrated enhanced coherence could be used to sense electric fields, strain, or temperature at the nanoscale, while retaining insensitivity to magnetic-field noise.

Additionally, the combination of accurate first-principles calculations and the ability to synthesize new molecular qubits with targeted properties highlights the promise of these molecular systems as testbeds to rapidly improve molecular color center properties through an iterative feedback loop of bottom-up design, chemical synthesis, qubit measurement, and theoretical modelling. For example, our results immediately point to even longer coherence by further increasing the transverse zero-field splitting to ˜10 GHz values, which should be readily accessible through engineering of both the composition of the qubit itself and its host matrix. This increase in |E| would result from a commensurate increase in |D|, which would serve to simultaneously enhance optical contrast in these systems. Thus, these results illustrate that precise control over the ground state spin structure improves key metrics of molecular color center performance. Overall, the flexibility of molecular color center design and accurate theoretical modelling provide tools to optimize the quantum properties of optically addressable spin systems for applications ranging from nanoscale quantum sensing to quantum networks and highlight the distinct opportunities available with a bottom-up qubit architecture.

The present embodiments include species and systems whose values of E may differ from those of the specific examples described above (i.e., 1, 2, 3, and 4). The value of E determines the frequency of the electromagnetic radiation used to drive the system, which may lie anywhere in the microwave (300 MHz to 300 GHz) or millimeter-wave (30 to 300 GHz) regions of the electromagnetic spectrum. However, these values are not limiting. Accordingly, the systems of the present embodiments may have values of E that are higher (i.e., greater than 300 GHz, such as terahertz radiation) or lower (i.e., less than 300 MHz, such as radio-frequency radiation) without departing from the scope hereof.

### Definitions

As used herein, the term “alkyl,” means a straight or branched chain hydrocarbon having the number of carbon atoms designated (i.e., C₁-C₆ alkyl means an alkyl having one to six carbon atoms) and includes straight and branched chains. Examples include methyl, ethyl, propyl, isopropyl, butyl, isobutyl, tert butyl, pentyl, neopentyl, and hexyl.

As used herein, the term “deuterated alkyl” refers to an alkyl group as defined herein wherein at least one hydrogen atom has been replaced with a deuterium atom. As such, deuterated alkyl groups of the disclosure may be partially deuterated or fully deuterated.

As used herein, the term “alkoxy” refers to the group —O-alkyl, wherein alkyl is as defined herein. Alkoxy includes, by way of example, methoxy, ethoxy, n-propoxy, isopropoxy, n-butoxy, sec-butoxy, t-butoxy and the like.

As used herein, the term “haloalkyl” refers to an alkyl group, as defined above, substituted with one or more halo substituents, wherein alkyl and halo are as defined herein.

Haloalkyl includes, by way of example, chloromethyl, trifluoromethyl, bromoethyl, chlorofluoroethyl, and the like.

As used herein, the term “aromatic” refers to a carbocycle or heterocycle with one or more polyunsaturated rings and having aromatic character, i.e., having (4n+2) delocalized π (pi) electrons, where n is an integer.

As used herein, the term “aryl” means an aromatic carbocyclic system. The term “aryl” includes, but is not limited to, phenyl, naphthyl, indanyl, and 1,2,3,4-tetrahydronaphthalenyl. In one embodiment, “aryl” means phenyl. In some embodiments, aryl groups have 6 carbon atoms. In some embodiments, aryl groups have from six to ten carbon atoms. In some embodiments, aryl groups have from six to sixteen carbon atoms.

As used herein, the term “deuterated aryl” refers to an aryl group as defined herein wherein at least one hydrogen atom has been replaced with a deuterium atom. As such, deuterated aryl groups of the disclosure may be partially deuterated or fully deuterated.

As used herein, the term “heteroaryl” means an aromatic carbocyclic system containing 1, 2, 3, or 4 heteroatoms selected independently from N, O, and S. The term “heteroaryl” includes, but is not limited to, furanyl, thienyl, oxazolyl, thiazolyl, imidazolyl, pyrazolyl, triazolyl, tetrazolyl, isoxazolyl, isothiazolyl, oxadiazolyl, thiadiazolyl, pyridinyl, pyridazinyl, pyrimidinyl, and pyrazinyl.

As used herein, the term “deuterated heteroaryl” refers to a heteroaryl group as defined herein wherein at least one hydrogen atom has been replaced with a deuterium atom. As such, deuterated heteroaryl groups of the disclosure may be partially deuterated or fully deuterated.

As used herein, the term “substituted” means that an atom or group of atoms has replaced hydrogen as the substituent attached to another group.

As used herein, the term “optionally substituted” means that the referenced group may be substituted or unsubstituted. In one embodiment, the referenced group is optionally substituted with zero substituents, i.e., the referenced group is unsubstituted. In another embodiment, the referenced group is optionally substituted with an additional group selected from the groups described herein.

### Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:
(A1) A molecular-spin qubit includes a molecular color center having a ground state with non-zero spin and an excited state, the ground state having at least first and second sublevels. The molecular-spin qubit also includes a host matrix that is non-isostructural with the molecular color center, the molecular color center being diluted in the host matrix. An optical transition between the ground state and the excited state lies in the optical region of the electromagnetic spectrum. A spin transition between the at least first and second sublevels lies in the microwave or millimeter-wave regions of the electromagnetic spectrum. Each of the first and second sublevels is first-order insensitive to magnetic fields near zero magnetic.
(A2) In the molecular-spin qubit denoted (A1), each of the first and second sublevels is first-order insensitive to magnetic fields near a nominal magnetic field of zero.
(A3) In either of the molecular-spin qubits denoted (A1) and (A2), the ground state is a spin-triplet state with three magnetic sublevels having magnetic quantum numbers m=−1, m=0, and m=+1. The first and second sublevels are selected from the group consisting of the three magnetic sublevels.
(A4) In any of the molecular-spin qubits denoted (A1) to (A3), a spin-lattice relaxation time of the ground state is greater than a lifetime of the excited state.
(A5) In any of the molecular-spin qubits denoted (A1) to (A4), the optical transition is a zero-phonon line.
(A6) In any of the molecular-spin qubits denoted (A1) to (A5), the molecular color center comprising a plurality of strong-field ligands bound to a metal-atom center.
(A7) In the molecular-spin qubit denoted (A6), the metal-atom center is a metal ion with a d² configuration.
(A8) In the molecular-spin qubit denoted (A7), the metal ion is a Cr⁴⁺ ion.
(A9) In any of the molecular-spin qubits denoted (A1) to (A8), the host matrix is a crystal.
(A10) In any of the molecular-spin qubits denoted (A1) to (A9), the host matrix has a lower symmetry than a host matrix that is isostructural with the molecular color center.
(A11) In any of the molecular-spin qubits denoted (A1) to (A10), the molecular color center comprises a first plurality of strong-field ligands bound to a first metal-atom center. The host matrix comprises a second plurality of strong-field ligands bound to a second metal-atom center.
(A12) In the molecular-spin qubit denoted (A11), each of the first and second metal-atom centers is selected from the group consisting of: Ti²⁺, Ti⁴⁺, V³⁺, Cr⁴⁺, Mo⁴⁺, W⁴⁺, Mn⁴⁺, Fe²⁺, Co¹⁺, Ge⁴⁺, Si⁴⁺, Sn⁴⁺, and Ni²⁺.
(A13) In either of the molecular-spin qubits denoted (A11) and (A12), each of the first and second pluralities of strong-field ligands is a monodentate ligand independently selected from the group consisting of cyano, nitro, amido, aryl, deuterated aryl, heteroaryl, and deuterated heteroaryl. Said aryl, deuterated aryl, heteroaryl, and deuterated heteroaryl are optionally substituted by one, two, or three substituents independently selected from the group consisting of C₁₋₆ alkyl, deuterated C₁₋₆ alkyl, halo, C₁₋₆ alkoxy, deuterated C₁₋₆ alkoxy, C₁₋₆ haloalkyl, and deuterated C₁₋₆ haloalkyl.
(A14) In any of the molecular-spin qubits denoted (A11) to (A13), a number of the first plurality of strong-field ligands is 4, 5, or 6. A number of the second plurality of strong-field ligands is 4, 5, or 6.
(A15) In any of the molecular-spin qubits denoted (A11) to (A14), the strong-field ligands of the first plurality are identical.
(A16) In any of the molecular-spin qubits denoted (A11) to (A15), the strong-field ligands of the second plurality are identical.
(A17) In any of the molecular-spin qubits denoted (A11) to (A16), the molecular color center is Cr(IV)(o-toyl)₄ and the host matrix is Sn(IV)(4-fluoro-2-methylphenyl)₄.

### REFERENCES

[1] C. L. Degen, F. Reinhard, and P. Cappellaro, Quantum Sensing, Rev. Mod. Phys. 89, 1 (2017).
[2] D. D. Awschalom, R. Hanson, J. Wrachtrup, and B. B. Zhou, Quantum Technologies with Optically Interfaced Solid-State Spins, Nat. Photon. 12, 516 (2018).
[3] H. Sen Zhong et al., Quantum Computational Advantage Using Photons, Science 370, 1460 (2020).
[4] D. Awschalom et al., Development of Quantum Interconnects (QuICs) for Next-Generation Information Technologies, PRX Quantum 2, 1 (2021).
[5] M. AtatGre, D. Englund, N. Vamivakas, S. Y. Lee, and J. Wrachtrup, Material Platforms for Spin-Based Photonic Quantum Technologies, Nat. Rev. Mat. 3, 38 (2018).
[6] G. Wolfowicz et al., Quantum Guidelines for Solid-State Spin Defects, Nat. Rev. Mat. 6, 906 (2021).
[7] M. Ruf, N. H. Wan, H. Choi, D. Englund, and R. Hanson, Quantum Networks Based on Color Centers in Diamond, J. Appl. Phys. 130, 070901 (2021).
[8] M. S. Fataftah and D. E. Freedman, Progress towards Creating Optically Addressable Molecular Qubits, Chem. Commun. 54, 13773 (2018).
[9] M. Atzori and R. Sessoli, The Second Quantum Revolution: Role and Challenges of Molecular Chemistry, J. Am. Chem. Soc. 141, 11339 (2019).
[10] S. L. Bayliss, D. W. Laorenza, P. J. Mintun, B. Diler, D. E. Freedman, and D. D. Awschalom, Optically Addressable Molecular Spins for Quantum Information Processing, Science 370, 1309 (2020).
[11] M. S. Fataftah et al., Trigonal Bipyramidal V³⁺ Complex as an Optically Addressable Molecular Qubit Candidate, J. Am. Chem. Soc. 142, 20400 (2020).
[12] M. K. Wojnar, D. W. Laorenza, R. D. Schaller, and D. E. Freedman, Nickel(II) Metal Complexes as Optically Addressable Qubit Candidates, J. Am. Chem. Soc. 142, 14826 (2020).
[13] D. W. Laorenza et al., Tunable Cr⁴⁺ Molecular Color Centers, J. Am. Chem. Soc. 143, 21350 (2021).
[14] G. Kucsko et al., Nanometre-Scale Thermometry in a Living Cell, Nature 500, 54 (2013).
[15] R. Schirhagl, K. Chang, M. Loretz, and C. L. Degen, Nitrogen-Vacancy Centers in Diamond: Nanoscale Sensors for Physics and Biology, Annu. Rev. Phys. Chem. 65, 83 (2014).
[16] J. F. Barry et al., Optical Magnetic Detection of Single-Neuron Action Potentials Using Quantum Defects in Diamond, Proc. Natl. Acad. Sci. U.S.A. 113, 14133 (2016).
[17] S. Thiele, F. Balestro, R. Ballou, S. Klyatskaya, M. Ruben, and W. Wernsdorfer, Electrically Driven Nuclear Spin Resonance in Single-Molecule Magnets, Science (2014).
[18] G. Czap et al., Probing and Imaging Spin Interactions with a Magnetic Single-Molecule Sensor, Science 364, 670 (2019).
[19] I. Cimatti et al., Vanadyl Phthalocyanines on Graphene SiC(0001): Toward a Hybrid Architecture for Molecular Spin Qubits, Nanoscale Horiz. 4, 1202 (2019).
[20] J. M. Zadrozny, J. Niklas, O. G. Poluektov, and D. E. Freedman, Millisecond Coherence Time in a Tunable Molecular Electronic Spin Qubit, ACS Cent. Sci. 1, 488 (2015).
[21] M. Shiddiq, D. Komijani, Y. Duan, A. Gaita-Ariño, E. Coronado, and S. Hill, Enhancing Coherence in Molecular Spin Qubits via Atomic Clock Transitions, Nature 531, 348 (2016).
[22] J. M. Zadrozny, A. T. Gallagher, T. D. Harris, and D. E. Freedman, A Porous Array of Clock Qubits, J. Am. Chem. Soc. 139, 7089 (2017).
[23] G. Wolfowicz et al., Atomic Clock Transitions in Silicon-Based Spin Qubits, Nat. Nanotechnol. 8, 561 (2013).
[24] K. C. Miao et al., Universal Coherence Protection in a Solid-State Spin Qubit, Science 369, 1493 (2020).
[25] C. J. Wedge et al., Chemical Engineering of Molecular Qubits, Phys. Rev. Lett. 108, (2012).
[26] W. F. Koehl, B. Diler, S. J. Whiteley, A. Bourassa, N. T. Son, E. Janzen, and D. D. Awschalom, Resonant Optical Spectroscopy and Coherent Control of Cr⁴⁺ Spin Ensembles in SiC and GaN, Phys. Rev. B 95, 035207 (2017).
[27] B. Diler et al., Coherent Control and High-Fidelity Readout of Chromium Ions in Commercial Silicon Carbide, npj Quantum Inf. 6, (2020).
[28] S. U. Koschmieder, B. S. McGilligan, G. McDermott, J. Arnold, G. Wilkinson, B. Hussain-Bates, and M. B. Hursthouse, Aryl and Aryne Complexes of Chromium, Molybdenum, and Tungsten. X-Ray Crystal Structures of [Cr(2-MeC6H4)(μ-2-MeC6H4)(PMe3)]2, Mo(H2-2-MeC6H3)(2-MeC6H4)2(PMe2Ph)2, and W(H2-2,5-Me2C6H2)(2,5-Me2C6H3)2-(PMe3)2, J. Chem. Soc., Dalton trans. 3427 (1990).
[29] C. Schneider-Koglin, B. Mathiasch, and M. Dräger, Über Tetraaryl-Methan-Analoga in Der Gruppe 14. III Ar₄Sn Pb (Ar Ph, p-, m-, o-Tol, 2,4-Xyl Und 2,5-Xyl): Gegenuberstellung von Bindungslangen Und Winkeln, von AMR Chemischen Verschiebungen Und Kopplungskonstanten Und von Schwingungsdaten, J. Organomet. Chem. 469, 25 (1994).
[30] M. Rubin-Osanz et al., Chemical Tuning of Spin Clock Transitions in Molecular Monomers Based on Nuclear Spin-Free Ni(II), Chem. Sci. 12, 5123 (2021).
[31] Rigaku, CrysAlisPro Software System, Version 1.171. 38.41 1, Rigaku Corporation (Rigaku Oxford Diffraction, U K, 2015).
[32] O. V. Dolomanov, L. J. Bourhis, R. J. Gildea, J. A. K. Howard, and H. Puschmann, OLEX2: A complete structure solution, refinement and analysis program, J. Appl. Cryst. 42, 339 (2009).
[33] G. M. Sheldrick, SHELXT—integrated space-group and crystal-structure determination, Acta Cryst. A 71, 3 (2015).
[34] G. M. Sheldrick, Crystal structure refinement with SHELXL, Acta Cryst. C71, 3 (2015).

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A molecular-spin qubit, comprising:
a molecular color center having a ground state with non-zero spin and an excited state, the ground state having at least first and second sublevels; and
a host matrix that is non-isostructural with the molecular color center, the molecular color center being diluted in the host matrix;
wherein:
an optical transition between the ground state and the excited state lies in the optical region of the electromagnetic spectrum;
a spin transition between the at least first and second sublevels lies in the microwave or millimeter-wave regions of the electromagnetic spectrum; and
each of the first and second sublevels is first-order insensitive to magnetic fields near zero magnetic.

2. The molecular-spin qubit of claim 1, wherein each of the first and second sublevels is first-order insensitive to magnetic fields near a nominal magnetic field of zero.

3. The molecular-spin qubit of claim 1, wherein:
the ground state is a spin-triplet state with three magnetic sublevels having magnetic quantum numbers m=−1, m=0, and m=+1; and
the first and second sublevels are selected from the group consisting of the three magnetic sublevels.

4. The molecular-spin qubit of claim 1, wherein a spin-lattice relaxation time of the ground state is greater than a lifetime of the excited state.

5. The molecular-spin qubit of claim 1, wherein the optical transition is a zero-phonon line.

6. The molecular-spin qubit of claim 1, the molecular color center comprising a plurality of strong-field ligands bound to a metal-atom center.

7. The molecular-spin qubit of claim 6, the metal-atom center being a metal ion with a d² configuration.

8. The molecular-spin qubit of claim 7, the metal ion being a Cr⁴⁺ ion.

9. The molecular-spin qubit of claim 1, the host matrix comprising a crystal.

10. The molecular-spin qubit of claim 1, wherein the host matrix has a lower symmetry than a host matrix that is isostructural with the molecular color center.

11. The molecular-spin qubit of claim 1, wherein:
the molecular color center comprises a first plurality of strong-field ligands bound to a first metal-atom center; and
the host matrix comprises a second plurality of strong-field ligands bound to a second metal-atom center.

12. The molecular-spin qubit of claim 11, wherein each of the first and second metal-atom centers is selected from the group consisting of: Ti²⁺, Ti⁴⁺, V³⁺, Cr⁴⁺, Mo⁴⁺, W⁴⁺, Mn⁴⁺, Fe²⁺, Co¹⁺, Ge⁴⁺, Si⁴⁺, Sn⁴⁺, and Ni²⁺.

13. The molecular-spin qubit of claim 11, wherein each of the first and second pluralities of strong-field ligands is a monodentate ligand independently selected from the group consisting of cyano, nitro, amido, aryl, deuterated aryl, heteroaryl, and deuterated heteroaryl, wherein said aryl, deuterated aryl, heteroaryl, and deuterated heteroaryl are optionally substituted by one, two, or three substituents independently selected from the group consisting of C₁₋₆ alkyl, deuterated C₁₋₆ alkyl, halo, C₁₋₆ alkoxy, deuterated C₁₋₆ alkoxy, C₁₋₆ haloalkyl, and deuterated C₁₋₆ haloalkyl.

14. The molecular-spin qubit of claim 11, wherein:
a number of the first plurality of strong-field ligands is 4, 5, or 6; and
a number of the second plurality of strong-field ligands is 4, 5, or 6.

15. The molecular-spin qubit of claim 11, wherein the strong-field ligands of the first plurality are identical.

16. The molecular-spin qubit of claim 11, wherein the strong-field ligands of the second plurality are identical.

17. The molecular-spin qubit of claim 1, wherein:
the molecular color center comprises Cr(IV)(o-toyl)₄; and
the host matrix comprises Sn(IV)(4-fluoro-2-methylphenyl)₄.

18. A crystal comprising:
a first metal-ligand complex; and
a host matrix comprising a second metal-ligand complex that is not isostructural with the first metal-ligand complex;
wherein the first metal-ligand complex is diluted in the host matrix.

19. The crystal of claim 18, wherein the ratio of the first metal-ligand complex to the second metal-ligand complex is less than or equal to 10%.

20. The crystal of claim 18, wherein the ratio of the first metal-ligand complex to the second metal-ligand complex is less than or equal to 1%.
